(19) United States
(12) Patent Application Publication
(10) Pub. No.: US 2014/0110307 A1
(43) Pub. Date: Apr. 24, 2014

(54) DUAL REACTOR FOR IMPROVED CONVERSION OF HEAVY HYDROCARBONS

(71) Applicant: MARATHON OIL CANADA CORPORATION, (US)

(72) Inventors: JOSE ARMANDO SALAZAR-GUILLEN, ASHLAND, KY (US); CHRISTOPHER ARD, SPARKS, NV (US); MAHENDRA JOSHI, KATY, TX (US); GREG LISEWSKY, SEABROOK, TX (US)

(73) Assignee: MARATHON OIL CANADA CORPORATION, CALGARY (CA)

(21) Appl. No.: 13/841,596

(22) Filed: Mar. 15, 2013

Related U.S. Application Data
(63) Continuation-in-part of application No. 12/816,844, filed on Jun. 16, 2010.

(51) Int. Cl. C10G 69/06; B01J 19/00

(52) U.S. Cl. CPC C10G 69/06; B01J 19/008
USPC 208/61; 422/128

(57) ABSTRACT

An improved hydrocarbon cracking process includes a first reactor such as a nozzle reactor positioned in series with a second reactor such as a tubular reactor. A cracking fluid such as steam or natural gas is reacted with heavy hydrocarbon material in the first reactor. The first reactor may provide a tremendous amount of thermal and kinetic energy that initiates cracking of heavy hydrocarbon materials. The second reactor provides sufficient residence time at high temperature to increase the conversion of heavy hydrocarbon materials to the desired level. The cracking fluid functions as a hydrogen donor in the cracking reactions so that very little of the heavy hydrocarbon material becomes hydrogen depleted and forms coke even if the heavy hydrocarbon material is repeatedly recycled through the process.

### CROSS-REFERENCE TO RELATED PATENT APPLICATIONS

This application is a Continuation-In-Part of U.S. patent application Ser. No. 12/816,844, filed Jun. 16, 2010. The entire contents of the following documents are incorporated by reference herein: U.S. Pat. Nos. 7,618,597, 7,927,565, and 7,988,847, U.S. patent application Ser. Nos. 12/579,193, 12/749,068, 12/761,204, 12/911,409, 13/227,470, 13/292,747, and U.S. Provisional Patent Application Nos. 61/526,434, 61/547,507, 61/553,009, 61/554,818, 61/579,948, 61/596,817, 61/596,826, and 61/646,641. In the event of a conflict, the subject matter explicitly recited or shown herein controls over any subject matter incorporated by reference.

### BACKGROUND

Since different crude oils yield different distillation products, oil refining requires balancing product yield with market demand. Balancing these two without manufacturing large quantities of low value fractions has long required processes for the conversion of hydrocarbons of one molecular weight range and/or structure into those of another molecular weight range and/or structure. The basic processes for this are the so-called cracking processes in which relatively high boiling constituents are cracked, that is, thermally decomposed, into lower molecular weight, smaller, lower boiling molecules.

Conventional thermal cracking is the thermal decomposition of high molecular weight constituents (higher molecular weight and higher boiling than gasoline constituents) to form lower molecular weight (and lower boiling) species. The earliest thermal cracking processes consisted of heating heavier oils (for which there was low market demand) in pressurized reactors and thereby cracking, or splitting, the large molecules into smaller ones that form the lighter, more valuable fractions such as gasoline, kerosene, and light industrial fuels.

The development of more powerful engines gave rise to a need to increase the combustion characteristics of gasoline to improve engine performance. Cracking processes were developed that used catalysts to improve the quality of transportation fuels and further increased their supply. These improved processes, including catalytic cracking of residual and other heavy feedstocks, alkylation, polymerization, and isomerization, enabled the petroleum industry to meet the demands of high performance engines and to supply increasing quantities of transportation fuels.

The continuing increase in demand for petroleum products also heightened the need to process a wider variety of crude oils into high quality products. Catalytic cracking is one of the leading processes for upgrading lighter oils (e.g., conventional crude oil) into high qualify fuel that meets the needs of higher compression engines. Hydrocracking, a catalytic cracking process conducted in the presence of hydrogen, was developed to be a versatile manufacturing process for increasing yields of gasoline and/or jet fuels.

The discovery of huge reserves of heavy oil has attracted renewed interest in thermal cracking processes. Thermal cracking processes such as visbreaking, an abbreviated term for viscosity breaking or viscosity lowering, are used to convert heavy, high viscosity, high boiling hydrocarbons to lower viscosity fractions suitable for further processing or use in heavy fuel oil. These processes may accomplish one or more of the following objectives. First, they reduce the viscosity of the feed stream, which may include heavy hydrocarbon sources such as the residue from distillation operations, the residue from hydroskimming operations, natural bitumen from sources such as tar sands, and even certain high viscosity crude oils. Second, they reduce the amount of residual fuel oil produced in a refinery, which is generally regarded as a low value product. Third, they increase the proportion of middle distillates produced in the refinery. Middle distillates are often used as a diluent for heavy hydrocarbons to lower their viscosity to a marketable level. Cracking the residual hydrocarbons reduces the diluent requirement so that the saved middle distillates can be diverted to higher value products.

In one example of a process for cracking heavy hydrocarbon material such as those mentioned above, the feed is passed through one or more tubes in a furnace. The heavy hydrocarbon material is heated to a high temperature causing partial vaporization and mild cracking. Conversion is achieved primarily as a result of temperature and residence time, which is why this process is described as being high temperature (e.g., 455 to 510° C.) and short residence time. The short residence time is the principal reason that this is considered a mild thermal reaction. The product that exits the tube is quenched to halt the cracking reactions. This may be done by heat exchange with the feed material, which saves energy, or with a stream of cold material such as gas oil to achieve the same effect.

These processes extend the boiling range of the heavy hydrocarbon materials so that light and heavy gas oils can be fractionated from the product stream, fed into a catalytic cracking unit, or otherwise processed further as desired. The yield of the various hydrocarbon products depends on the “severity” of the cracking operation as determined by the temperature the feed is heated to in the furnace. At the low end of the scale, a furnace operating at 425° C. would crack only mildly, while operations at 500° C. would be considered as very severe. Arabian light crude residue cracked at 450° C. would yield around 76 wt % tar, 15 wt % middle distillates, 6 wt % gasolines and 3 wt % gas and LPG.

One problem commonly encountered when cracking heavy hydrocarbon materials is excessive coke formation. As thermal cracking proceeds, reactive unsaturated molecules are formed that continue to react and can ultimately create higher molecular weight species that are relatively hydrogen deficient and readily form coke. The coke is deposited on the cracking equipment and leads to fouling and necessitates frequent cleaning. This is especially a problem in tubular reactors. The coke is deposited in the reaction tubes and eventually fouls or blocks them. Tubular reactors require frequent de-coking, which is labor intensive and can result in substantial downtime.

Another disadvantage of processes for cracking heavy hydrocarbon material is that, unlike conventional thermal cracking, they do not employ a recycle stream. Conditions are too mild to crack a gas oil recycle stream, and the unconverted heavy hydrocarbon material, if recycled, would cause excessive coking. Further cracking of the residuals must be done in a separate unit that can remove the very heavy fractions that are left.

Processes for cracking heavy hydrocarbon material also produce a significant amount of gaseous hydrocarbons as a by-product. Although these can be separated for other uses, it is preferable to limit the amount of gases produced to maximize liquid yields.

### SUMMARY

A system for cracking heavy hydrocarbon material includes a first reactor and a second reactor positioned in series. A feed that includes heavy hydrocarbon material and a cracking fluid are input into the first reactor where the heavy hydrocarbon material begins to crack into lighter hydrocarbon material. The cracking fluid is accelerated to supersonic speed in the first reactor and then mixed with the feed to initiate cracking of the heavy hydrocarbons. The cracking fluid functions as a hydrogen source thereby minimizing coke formation due to excessive hydrogen loss from the heavy hydrocarbon material. In one embodiment, the first reactor includes a nozzle reactor.

The second reactor provides the residence time at high temperature that further drives conversion of the heavy hydrocarbon material to lighter hydrocarbons. The second reactor may be a tubular reactor such as a coil reactor. The residence time and linear velocity of the heavy hydrocarbon material in the second reactor may be approximately 0.05 s to 1 s and approximately 4 to 40 m/s, respectively.

The effluent from the second reactor may be separated to isolate any remaining heavy hydrocarbon material. The heavy hydrocarbon material may then be recycled back to the first reactor until it is completely eliminated. The recycled heavy hydrocarbon material does not produce significant amounts of coke due to the hydrogen supplied by the cracking fluid. The entire process may be operated without the use of a catalyst or added hydrogen.

The foregoing and other features, utilities, and advantages of the subject matter described herein will be apparent from the following more particular description of certain embodiments as illustrated in the accompanying drawings.

The term “heavy hydrocarbon material” is used to refer to the hydrocarbon fraction that has a boiling point at or above 525° C. This material may be obtained from a number of sources such as the residue from distillation operations such as atmospheric or vacuum distillation, the residue from hydroskimming operations, natural sources such as tar sands (including oil sands and oil shale), and even certain high viscosity crude oils. The term “distillates” is used to refer to the hydrocarbon fraction that has a boiling point below 525° C. The term “coke precursor” is used to refer to carbon based material that is not soluble in toluene. It should be appreciated that all pressures are given as gauge pressures unless noted otherwise.

### DRAWINGS

FIG. 1 is a schematic representation of one embodiment of a system for cracking heavy hydrocarbon material.

FIG. 2 is a schematic representation of another embodiment of a system for cracking heavy hydrocarbon material that includes recycle of unconverted heavy hydrocarbon material.

FIG. 3 shows an exemplary embodiment of a nozzle reactor that may be used in the process.

FIG. 4 shows an exemplary embodiment of a nozzle reactor coupled in series with a coil reactor.

FIG. 5 shows an exemplary embodiment of a method for cracking heavy hydrocarbon material.

FIG. 6

FIG. 7

FIG. 8

FIG. 9

FIG. 10

### DETAILED DESCRIPTION

An improved process for cracking or upgrading heavy hydrocarbon material is described herein. Although the process is described primarily in the context of upgrading heavy hydrocarbon materials, it should be appreciated that the process, concepts, and features described herein may be used in a variety of other settings that would be recognized by those of ordinary skill in the art (e.g., upgrading distillates). Also, it should be understood, that the features, advantages, characteristics, etc. of one embodiment may be applied to any other embodiment to form an additional embodiment unless noted otherwise.

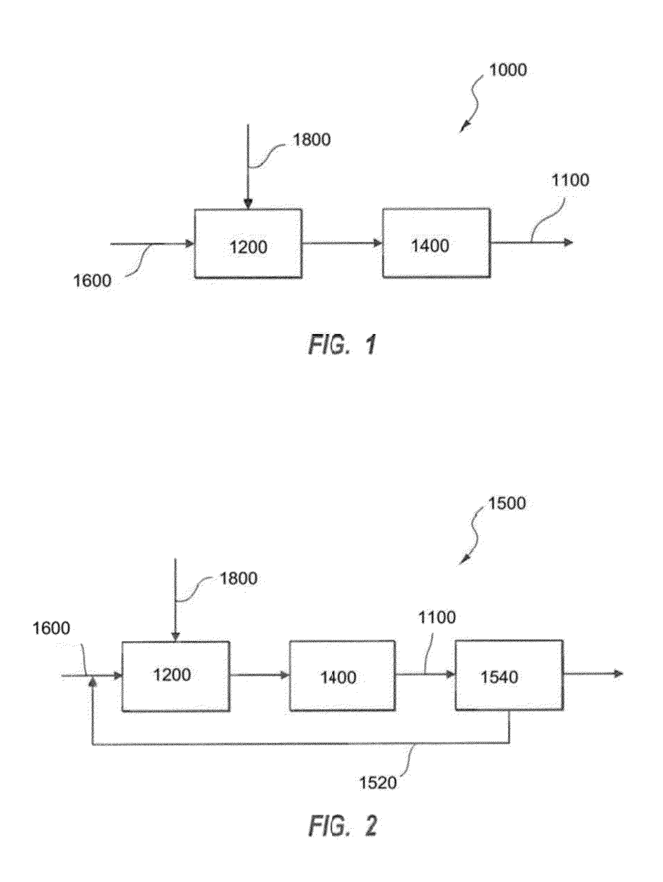

FIG. 1 shows one embodiment of a system 1000 for cracking heavy hydrocarbon material. The system includes a first reactor 1200 and a second reactor 1400 positioned in series. The first reactor 1200 partially upgrades the heavy hydrocarbon material and the second reactor 1400 further upgrades it until it reaches the overall desired conversion level. The second reactor 1400 discharges an upgraded effluent material 1100.

Heavy hydrocarbon material is fed to the first reactor 1200 in the feed 1600. A cracking fluid 1800 is also fed to the first reactor. The heavy hydrocarbon material may be obtained from a variety of sources. Examples of suitable sources include the residual fraction of distillation operations such as atmospheric or vacuum distillation or from the residual fraction of hydroskimming operations. Other sources include natural sources such as oil sands (which includes tar sands, oil shale, etc.) or even certain high viscosity crude oils.

The composition of the feed 1600 can vary widely, but often includes asphaltenes, resins, aromatic hydrocarbons, and alkanes in varying amounts. Asphaltenes are large polycyclic molecules that are commonly defined as those molecules that are insoluble in n-heptane and soluble in toluene. Resins are also polycyclic but have a lower molecular weight than asphaltenes. Aromatic hydrocarbons are derivatives of benzene, toluene and xylene. The feed may also include 12 to 25 wt % micro carbon as determined using ASTM D4530-07.

The feed 1600 may include heavy hydrocarbon material and other lower boiling fractions. In most situations, it is advantageous to separate any distillates from the feed 1600 so that it is composed entirely or almost entirely of heavy hydrocarbon material when it enters the first reactor 1200. Any suitable separation process (e.g., distillation, etc.) may be used to separate the distillates. In some embodiments, the feed 1600 includes at least approximately 95 wt % heavy hydrocarbon material, at least approximately 98 wt % heavy hydrocarbon material, or, desirably, at least approximately 99 wt % heavy hydrocarbon material. It should be appreciated that in other embodiments, the feed 1600 may include a substantial amount of distillates.

The feed 1600 is preheated before it enters the nozzle reactor to a temperature that is just below the temperature at which the cracking occurs. This imparts the maximum amount of energy to the feed 1600 without initiating cracking. In some embodiments the feed 1600 may be heated to a temperature that is no more than 400° C. In other embodiments, the feed 1600 may be heated to at least approximately 350° C. In other embodiments, the feed 1600 may be heated to approximately 350° C. to 400° C.

The cracking fluid 1800 may be any material that when combined with the feed 1600 in the first reactor 1200 and the second reactor 1400 cracks the heavy hydrocarbon material and/or serves as a hydrogen donor to the hydrocarbon material. The cracking fluid 1800 may be supplied as a superheated fluid. Suitable cracking fluids include steam, natural gas, carbon dioxide, methanol, ethanol, ethane, propane, nitrogen, biodiesel, carbon dioxide, other gases, or combinations thereof. In some embodiments, the cracking fluid 1800 is superheated steam, natural gas, or a combination of both.

The cracking fluid 1800 may help to prevent the formation of coke in the system 1000 by functioning as a hydrogen donor in the cracking reactions. The hydrogen from the cracking fluid 1800 is transferred to the heaviest hydrocarbons thereby preventing them from becoming hydrogen depleted in the extreme conditions of the reactors 1200, 1400.

The cracking fluid 1800 may be heated and pressurized before it is introduced to the first reactor 1200. The heat and pressure give the cracking fluid 1800 added energy that is transferred to the heavy hydrocarbon material causing it to crack or scission. The cracking fluid 1800 may be provided in an amount and at a temperature sufficient to heat the feed 1600 to the desired temperature and initiate the cracking reactions. The amount of heat supplied in the cracking fluid 1800 may be determined using a mass and energy balance.

In some embodiments, the cracking fluid 1800 may be supplied at a temperature of at least approximately 550° C. or at least approximately 600° C. In other embodiments, the cracking fluid 1800 may be supplied at a temperature of approximately 550° C. to 700° C. or approximately 600° C. to 650° C. In other embodiments, the cracking fluid 1800 may be supplied at a temperature of no more than approximately 700° C.

In some embodiments, the cracking fluid 1800 may be pressurized to at least approximately 1380 kPa or at least approximately 3100 kPa. In other embodiments, the cracking fluid 1800 may be pressurized to approximately 1380 kPa to 6200 kPa or approximately 3100 kPa to 5170 kPa. In other embodiments, the cracking fluid 1800 may be pressurized no more than approximately 6200 kPa or no more than approximately 5170° C.

The ratio of cracking fluid 1800 to feed 1600 supplied to the first reactor 1200 may vary depending on a number of factors. In general, it is desirable to minimize the amount of cracking fluid 1800 while still successfully cracking the heavy hydrocarbons to reduce cost. In some embodiments, the ratio of cracking fluid 1800 to feed 1600 is no more than 2.0 or no more than 1.7. In some embodiments, the ratio of cracking fluid 1800 to feed 1600 may be approximately 0.5 to 2.0 or approximately 1.0 to 1.7. In some embodiments, the ratio of cracking fluid 1800 to feed 1600 is at least approximately 0.5 or at least approximately 1.0

It should be appreciated that the first reactor 1200 may be any suitable reactor capable of at least partially upgrading heavy hydrocarbon material. In some embodiments, the first reactor 1200 is a nozzle reactor. A nozzle reactor includes any type of apparatus wherein differing types of materials are injected into an interior reactor chamber for the purpose of chemically and/or mechanically interacting with each other.

The nozzle reactor may have any of a number of suitable configurations. In some embodiments, the nozzle reactor accelerates the cracking fluid to supersonic velocities and collides it with the heavy hydrocarbon material. In this way, the nozzle reactor generates a tremendous amount of thermal and kinetic energy.

In some embodiments, the nozzle reactor is configured to accelerate the cracking fluid to at least approximately Mach 1, at least approximately Mach 1.5, or, desirably, at least approximately Mach 2. In some embodiments, the nozzle reactor may accelerate the cracking fluid to approximately Mach 1 to 7, approximately Mach 1.5 to 6, or, desirably, approximately Mach 2 to 5.

The cracking produced in the nozzle reactor is influenced by a number of factors such as temperature, residence time, pressure, and impact force. Without wishing to be bound by theory, it appears that the mechanical forces exerted on the heavy hydrocarbon material due to the impact of the cracking fluid is a significant factor in the success of the system 1000. The impact force weakens the molecule making it more susceptible to chemical attack and/or directly cleaves it apart.

In some embodiments, the nozzle reactor is the same or substantially similar to the nozzle reactor disclosed in U.S. Pat. No. 7,618,597, U.S. patent application Ser. No. 13/227,470, or U.S. Provisional Patent Application No. 61/596,826. The nozzle reactor may generally include an interior reactor chamber, an injection passage, and a material feed passage. The interior reactor chamber may have an injection end and an ejection end. The injection passage is positioned in fluid communication with the injection end of the interior reactor chamber.

In some embodiments, the injection passage is roughly shaped like an hourglass with enlarged openings at the entrance (the enlarged volume injection section) and exit (the enlarged volume ejection section) and a restricted or narrowed area in the middle. The cracking fluid 1800 enters the nozzle reactor through the injection passage. The cracking fluid 1800 enters the injection passage at a material injection end and exits the passage at a material ejection end. The injection passage opens to the interior reactor chamber.

The heavy hydrocarbon material enters the nozzle reactor through the material feed passage, which is in fluid communication with the interior reactor chamber and is generally located adjacent to the location where the cracking fluid 1800 exits the injection passage. Additionally, the feed passage is positioned transverse to the direction of the injection passage.

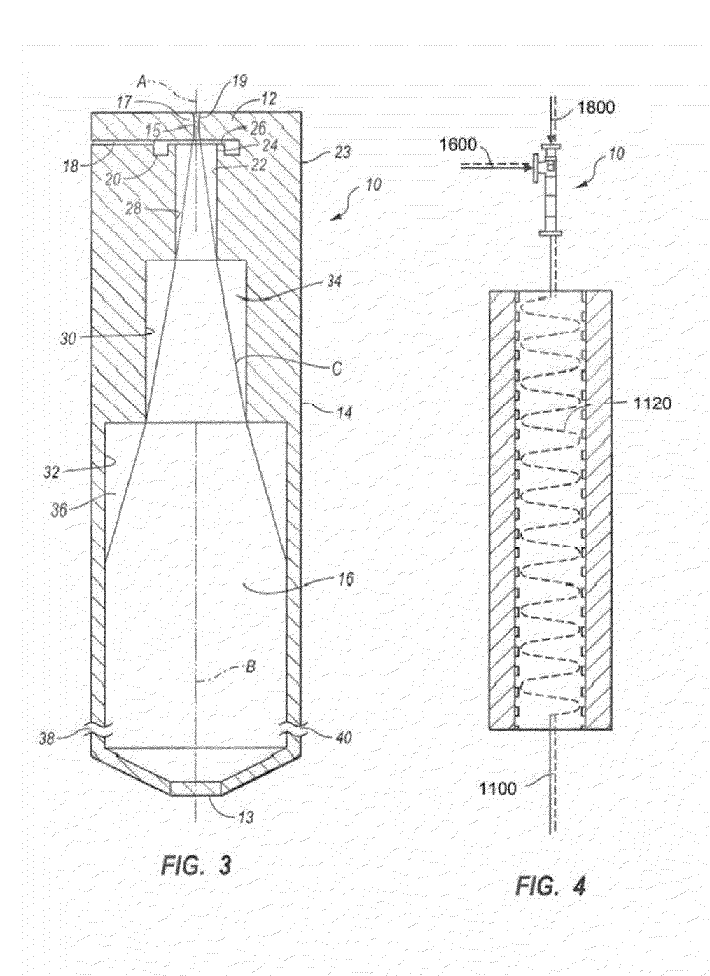

Turning to FIG. 3, an exemplary embodiment of a nozzle reactor 10 is shown. The nozzle reactor 10 has a reactor body injection end 12, a reactor body 14 extending from the reactor body injection end 12, and an ejection port 13 in the reactor body 14 opposite its injection end 12. The reactor body injection end 12 includes an injection passage 15 extending into the interior reactor chamber 16 of the reactor body 14. The central axis A of the injection passage 15 is coaxial with the central axis B of the interior reactor chamber 16.

The injection passage 15 has a circular diametric cross-section and, as shown in the axially-extending cross-sectional view of FIG. 2, opposing inwardly curved side wall portions 17, 19 (i.e., curved inwardly toward the central axis A of the injection passage 15) extending along the axial length of the injection passage 15. In certain embodiments, the axially inwardly curved side wall portions 17, 19 of the injection passage 15 facilitate high speed injection of the cracking fluid 1800 as it passes through the injection passage 15 into the interior reactor chamber 16.

The side wall of the injection passage 15 can provide one or more of the following: (i) uniform axial acceleration of the cracking fluid 1800 passing through the injection passage 15; (ii) minimal radial acceleration of such material; (iii) a smooth finish; (iv) absence of sharp edges; and (v) absence of sudden or sharp changes in direction. The side wall configuration can render the injection passage 15 substantially isentropic.

A feed passage 18 extends from the exterior of the reactor body 14 toward the interior reaction chamber 16 transversely to the axis B of the interior reactor chamber 16. The feed passage 18 penetrates an annular feed port 20 adjacent the interior reactor chamber wall 22 at the interior reactor chamber injection end 24 abutting the reactor body injection end 12.

The feed port 20 includes an annular, radially extending reactor chamber feed slot 26 in fluid communication with the interior reactor chamber 16. The feed port 20 is thus configured to inject the feed 1600: (i) at about a 90° angle to the axis of travel of the cracking fluid 1800 injected from the injection passage 15; (ii) around the entire circumference of a cracking fluid 1800 injected through the injection passage 15; and (iii) to impact the entire circumference of the cracking fluid stream virtually immediately upon its emission from the injection passage 15 into the interior reactor chamber 16.

The annular feed port 20 may have a U-shaped or C-shaped cross-section among others. In certain embodiments, the annular feed port 20 may be open to the interior reactor chamber 16, with no arms or barrier in the path of fluid flow from the feed passage 18 toward the interior reactor chamber 16. The junction of the annular feed port 20 and the feed passage 18 can have a radiused cross-section.

The interior reactor chamber 16 may be bounded by stepped, telescoping side walls 28, 30, 32 extending along the axial length of the reactor body 14. In certain embodiments, the stepped side walls 28, 30, 32 are configured to: (i) allow a free jet of injected cracking fluid 1800 to travel generally along and within the conical jet path C generated by the injection passage 15 along the axis B of the interior reactor chamber 16, while (ii) reducing the size or involvement of back flow areas (e.g., 34, 36) outside the conical or expanding jet path C, thereby forcing increased contact between the high speed cracking fluid stream within the conical jet path C and the feed 1600 injected through the annular feed port 20.

As indicated by the drawing gaps 38, 40 in the embodiment of FIG. 3, the reactor body 14 has an axial length (along axis B) that is much greater than its width. In the embodiment shown in FIG. 3, exemplary length-to-width ratios are typically in the range of 2 to 7 or more.

The dimensions of the various components of the nozzle reactor shown in FIG. 3 are not limited, and may generally be adjusted based on the amount of feed flow rate. Table 1 provides exemplary dimensions for the various components of the nozzle reactor 10 based on the hydrocarbon input in barrels per day (BPD).

TABLE 1
Exemplary nozzle reactor specifications

| | Feed Input (BPD) | | |
|---|---|---|---|
| Nozzle Reactor Component (mm) | 5,000 | 10,000 | 20,000 |
| Injection passage entrance section | 148 | 207 | 295 |
| diameter | | | |
| Injection passage mid-section diameter | 50 | 70 | 101 |
| Injection passage exit section diameter | 105 | 147 | 210 |
| Injection passage length | 600 | 840 | 1,200 |
| Interior reaction chamber injection end | 187 | 262 | 375 |
| diameter | | | |
| Interior reaction chamber ejection end | 1,231 | 1,435 | 1,821 |
| diameter | | | |
| Interior reaction chamber length | 640 | 7,160 | 8,800 |
| Overall nozzle reactor length | 7,000 | 8,000 | 10,000 |
| Overall nozzle reactor outside diameter | 1,300 | 1,600 | 2,000 |
| Overall nozzle reactor length 10 outside | 5.4 | 5.0 | 5.0 |
| diameter ratio | | | |

The use of the nozzle reactor 10 to crack the heavy hydrocarbon material is described in greater detail. The feed 1600, which includes the heavy hydrocarbon material is injected into the interior reactor chamber 16 via the feed passage 18. The feed 1600 may be pretreated prior to entering the nozzle reactor 10 to alter the amount or fraction of heavy hydrocarbon material. The feed 1600 may also be pretreated to alter other characteristics of the feed.

The feed 1600 and the cracking fluid 1800 are simultaneously injected into the interior reactor chamber 16 through feed passage 18 and injection passage 15. The configuration of the injection passage 15 is such that the cracking fluid 1800 is accelerated to supersonic speed and enters the interior reactor chamber 16 at supersonic speed. The cracking fluid 1800 produces shock waves that facilitate mechanical and chemical scission of the heavy hydrocarbon material. In this manner, the heavy hydrocarbon material may be broken down into lighter hydrocarbon molecules.

The nozzle reactor's conversion rate of heavy hydrocarbon material into distillates varies depending on the inputs, conditions, and a number of other factors. In one embodiment, the conversion rate of the nozzle reactor 10 is at least approximately 2%, at least approximately 4%, or, desirably, at least approximately 8%. In another embodiment, the conversion rate of the nozzle reactor 10 is approximately 2% to 25%, approximately 4% to 20%, or, desirably, approximately 8% to 16%.

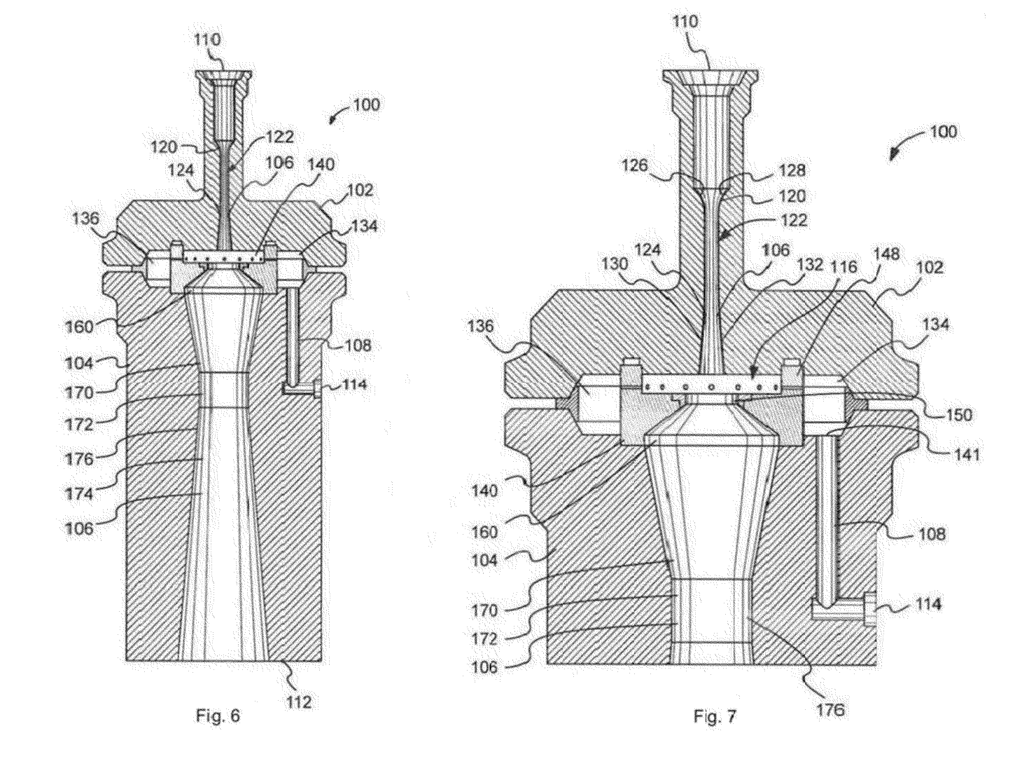

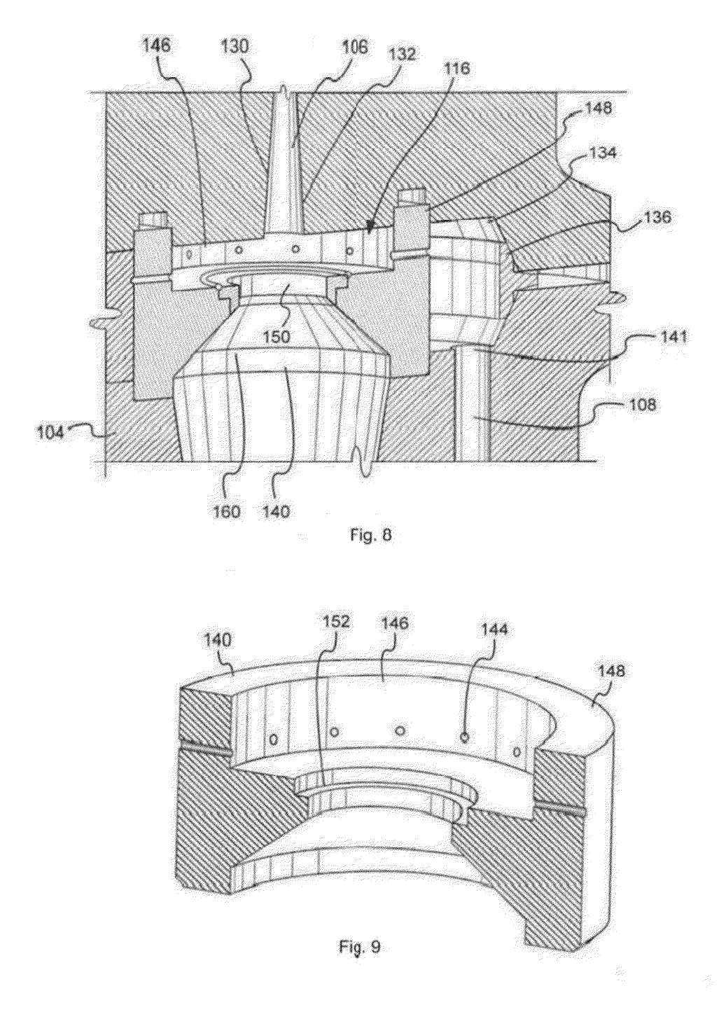

Turning to FIGS. 6 and 7, another exemplary embodiment of a nozzle reactor suitable for use in the process described herein is shown. The nozzle reactor 100 includes a head portion 102 coupled to a body portion 104. A main passage 106 extends through both the head portion 102 and the body portion 104. The head and body portions 102, 104 are coupled together so that the central axes of the main passage 106 in each portion 102, 104 are coaxial so that the main passage 106 extends straight through the nozzle reactor 100.

It should be noted that for purposes of this disclosure, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

The nozzle reactor 100 includes a feed passage 108 that is in fluid communication with the main passage 106. The feed passage 108 intersects the main passage 106 at a location between the portions 102, 104. The main passage 106 includes an entry opening 110 at the top of the head portion 102 and an exit opening 112 at the bottom of the body portion 104. The feed passage 108 also includes an entry opening 114 on the side of the body portion 104 and an exit opening 116 that is located where the feed passage 108 meets the main passage 106.

During operation, the nozzle reactor 100 includes a reacting fluid that flows through the main passage 106. The reacting fluid enters through the entry opening 110, travels the length of the main passage 106, and exits the nozzle reactor 100 out of the exit opening 112. A feed material flows through the feed passage 108. The feed material enters through the entry opening 114, travels through the feed passage 106, and exits into the main passage 108 at exit opening 116.

The main passage 106 is shaped to accelerate the reacting fluid. The main passage 106 may have any suitable geometry that is capable of doing this. As shown in FIGS. 6 and 7, the main passage 106 includes a first region having a convergent section 120 (also referred to herein as a contraction section), a throat 122, and a divergent section 124 (also referred to herein as an expansion section). The first region is in the head portion 102 of the nozzle reactor 100.

The convergent section 120 is where the main passage 106 narrows from a wide diameter to a smaller diameter, and the divergent section 124 is where the main passage 106 expands from a smaller diameter to a larger diameter. The throat 122 is the narrowest point of the main passage 106 between the convergent section 120 and the divergent section 124. When viewed from the side, the main passage 106 appears to be pinched in the middle, making a carefully balanced, asymmetric hourglass-like shape. This configuration is commonly referred to as a convergent-divergent nozzle or “con-di nozzle”.

The convergent section of the main passage 106 accelerates subsonic fluids since the mass flow rate is constant and the material must accelerate to pass through the smaller opening. The flow will reach sonic velocity or Mach 1 at the throat 122 provided that the pressure ratio is high enough. In this situation, the main passage 106 is said to be in a choked flow condition.

Increasing the pressure ratio further does not increase the Mach number at the throat 122 beyond unity. However, the flow downstream from the throat 122 is free to expand and can reach supersonic velocities. It should be noted that Mach 1 can be a very high speed for a hot fluid since the speed of sound varies as the square root of absolute temperature. Thus the speed reached at the throat 122 can be far higher than the speed of sound at sea level.

The divergent section 124 of the main passage 106 slows subsonic fluids, but accelerates sonic or supersonic fluids. A convergent-divergent geometry can therefore accelerate fluids in a choked flow condition to supersonic speeds. The convergent-divergent geometry can be used to accelerate the hot, pressurized reacting fluid to supersonic speeds, and upon expansion, to shape the exhaust flow so that the heat energy propelling the flow is maximally converted into kinetic energy.

The flow rate of the reacting fluid through the convergent-divergent nozzle is isentropic (fluid entropy is nearly constant). At subsonic flow the fluid is compressible so that sound, a small pressure wave, can propagate through it. At the throat 122, where the cross sectional area is a minimum, the fluid velocity locally becomes sonic (Mach number=1.0). As the cross sectional area increases the gas begins to expand and the gas flow increases to supersonic velocities where a sound wave cannot propagate backwards through the fluid as viewed in the frame of reference of the nozzle (Mach number>1.0).

The main passage 106 only reaches a choked flow condition at the throat 122 if the pressure and mass flow rate is sufficient to reach sonic speeds, otherwise supersonic flow is not achieved and the main passage will act as a venturi tube. In order to achieve supersonic flow, the entry pressure to the nozzle reactor 100 should be significantly above ambient pressure.

The pressure of the fluid at the exit of the divergent section 124 of the main passage 106 can be low, but should not be too low. The exit pressure can be significantly below ambient pressure since pressure cannot travel upstream through the supersonic flow. However, if the pressure is too far below ambient, then the flow will cease to be supersonic or the flow will separate within the divergent section 124 of the main passage 106 forming an unstable jet that “flops” around and damages the main passage 106. In one embodiment, the ambient pressure is no higher than approximately 2-3 times the pressure in the supersonic gas at the exit.

The supersonic reacting fluid collides and mixes with the feed material in the nozzle reactor 100 to produce the desired reaction. The high speeds involved and the resulting collision produces a significant amount of kinetic energy that helps facilitate the desired reaction. The reacting fluid and/or the feed material may also be pre-heated to provide additional thermal energy to react the materials.

The nozzle reactor 100 may be configured to accelerate the reacting fluid to at least approximately Mach 1, at least approximately Mach 1.5, or, desirably, at least approximately Mach 2. The nozzle reactor may also be configured to accelerate the reacting fluid to approximately Mach 1 to approximately Mach 7, approximately Mach 1.5 to approximately Mach 6, or, desirably, approximately Mach 2 to approximately Mach 5.

As shown in FIG. 7, the main passage 106 has a circular cross-section and opposing converging side walls 126, 128. The side walls 126, 128 curve inwardly toward the central axis of the main passage 106. The side walls 126, 128 form the convergent section 120 of the main passage 106 and accelerate the reacting fluid as described above.

The main passage 106 also includes opposing diverging side walls 130, 132. The side walls 130, 132 curve outwardly (when viewed in the direction of flow) away from the central axis of the main passage 106. The side walls 130, 132 form the divergent section 124 of the main passage 106 that allows the sonic fluid to expand and reach supersonic velocities.

The side walls 126, 128, 130, 132 of the main passage 106 provide uniform axial acceleration of the reacting fluid with minimal radial acceleration. The side walls 126, 128, 130, 132 may also have a smooth surface or finish with an absence of sharp edges that may disrupt the flow. The configuration of the side walls 126, 128, 130, 132 renders the main passage 106 substantially isentropic.

The feed passage 108 extends from the exterior of the body portion 104 to an annular chamber 134 formed by head and body portions 102, 104. The portions 102, 104 each have an opposing cavity so that when they are coupled together the cavities combine to form the annular chamber 134. A seal 136 is positioned along the outer circumference of the annular chamber 134 to prevent the feed material from leaking through the space between the head and body portions 102, 104.

It should be appreciated that the head and body portions 102, 104 may be coupled together in any suitable manner. Regardless of the method or devices used, the head and body portions 102, 104 should be coupled together in a way that prevents the feed material from leaking and withstands the forces generated in the interior. In one embodiment, the portions 102, 104 are coupled together using bolts that extend through holes in the outer flanges of the portions 102, 104.

The nozzle reactor 100 includes a distributor 140 positioned between the head and body portions 102, 104. The distributor 140 prevents the feed material from flowing directly from the opening 141 of the feed passage 108 to the main passage 106. Instead, the distributor 140 annularly and uniformly distributes the feed material into contact with the reacting fluid flowing in the main passage 106.

As shown in FIG. 9, the distributor 140 includes an outer circular wall 148 that extends between the head and body portions 102, 104 and forms the inner boundary of the annular chamber 134. A seal or gasket may be provided at the interface between the distributor 140 and the head and body portions 102, 104 to prevent feed material from leaking around the edges.

The distributor 140 includes a plurality of holes 144 that extend through the outer wall 148 and into an interior chamber 146. The holes 144 are evenly spaced around the outside of the distributor 140 to provide even flow into the interior chamber 146. The interior chamber 146 is where the main passage 106 and the feed passage 108 meet and the feed material comes into contact with the supersonic reacting fluid.

The distributor 140 is thus configured to inject the feed material at about a 90° angle to the axis of travel of the reacting fluid in the main passage 106 around the entire circumference of the reacting fluid. The feed material thus forms an annulus of flow that extends toward the main passage 106. The number and size of the holes 144 are selected to provide a pressure drop across the distributor 140 that ensures that the flow through each hole 144 is approximately the same. In one embodiment, the pressure drop across the distributor is at least approximately 2000 pascals, at least approximately 3000 pascals, or at least approximately 5000 pascals.

The distributor 140 includes a wear ring 150 positioned immediately adjacent to and downstream of the location where the feed passage 108 meets the main passage 106. The collision of the reacting fluid and the feed material causes a lot of wear in this area. The wear ring is a physically separate component that is capable of being periodically removed and replaced.

As shown in FIG. 9, the distributor 140 includes an annular recess 152 that is sized to receive and support the wear ring 150. The wear ring 150 is coupled to the distributor 140 to prevent it from moving during operation. The wear ring 150 may be coupled to the distributor in any suitable manner. For example, the wear ring 150 may be welded or bolted to the distributor 140. If the wear ring 150 is welded to the distributor 140, as shown in FIG. 8, the wear ring 150 can be removed by grinding the weld off. In some embodiments, the weld or bolt need not protrude upward into the interior chamber 146 to a significant degree.

The wear ring 150 can be removed by separating the head portion 102 from the body portion 104. With the head portion 102 removed, the distributor 140 and/or the wear ring 150 are readily accessible. The user can remove and/or replace the wear ring 150 or the entire distributor 140, if necessary.

As shown in FIGS. 6 and 7, the main passage 106 expands after passing through the wear ring 150. This can be referred to as expansion area 160 (also referred to herein as an expansion chamber). The expansion area 160 is formed largely by the distributor 140, but can also be formed by the body portion 104.

Following the expansion area 160, the main passage 106 includes a second region having a converging-diverging shape. The second region is in the body portion 104 of the nozzle reactor 100. In this region, the main passage includes a convergent section 170 (also referred to herein as a contraction section), a throat 172, and a divergent section 174 (also referred to herein as an expansion section). The converging-diverging shape of the second region differs from that of the first region in that it is much larger. In one embodiment, the throat 172 is at least 2-5 times as large as the throat 122.

The second region provides additional mixing and residence time to react the reacting fluid and the feed material. The main passage 106 is configured to allow a portion of the reaction mixture to flow backward from the exit opening 112 along the outer wall 176 to the expansion area 160. The backflow then mixes with the stream of material exiting the distributor 140. This mixing action also helps drive the reaction to completion.

It should be appreciated that the second reactor 1400 may be any suitable reactor capable of further upgrading the heavy hydrocarbon material. In one embodiment, the second reactor 1400 is a tubular reactor. The tubular reactor may be any suitable reactor capable of converting the requisite amount of heavy hydrocarbon material into lighter distillates. The tubular reactor provides enough residence time at high temperature and high velocity to provide the overall desired level of conversion of heavy hydrocarbon material. The tubular reactor includes a tube that generally has a uniform internal diameter and may be linear or non-linear.

In one embodiment, the tubular reactor may be a non-linear tubular reactor such as the coil reactor 1120 shown in FIG. 4. The non-linear shape of the coil reactor 1120 forces the material to repeatedly change direction as it passes through the tube. This causes greater mixing and faster reaction time between the heavy hydrocarbon material and the cracking fluid 1800.

The coil configuration affects the temperature and pressure distribution as well as the product yields. The coil reactor 1120 is spiral shaped, but it should be appreciated that the coil reactor 1120 may have any suitable non-linear shape. Other suitable shapes include a single row, split, reversed split, etc. Coil reactors typically increase the rate of conversion of heavy hydrocarbon materials as well as the amount converted making this the preferred tubular reactor configuration for most situations.

As shown in FIG. 4, the feed 1600 and cracking material 1800 pass directly from the nozzle reactor 10 to the coil reactor 1120. This quick transition allows the materials to enter the coil reactor 1120 without losing too much heat or velocity. It should be appreciated, however, that the materials may undergo some form of processing or treatment after leaving the nozzle reactor 10 but before entering the coil reactor 1120.

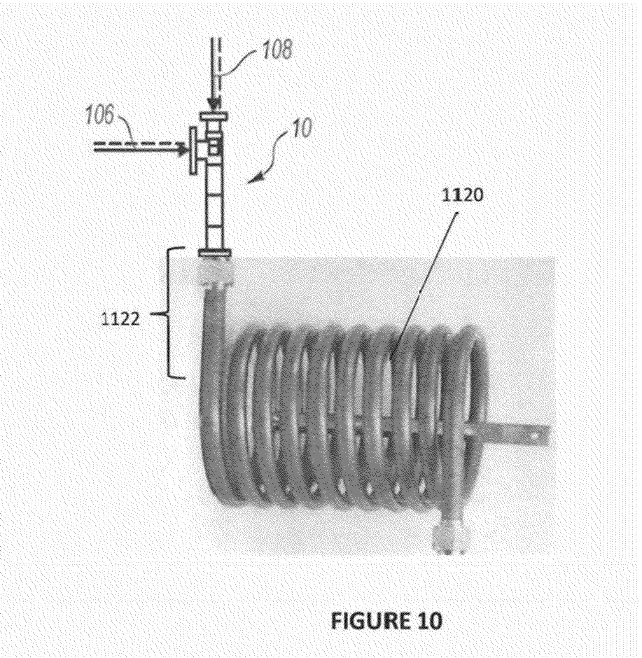

As show in FIG. 10, the coil reactor 1120 can be aligned such that the axis of the coil reactor 1120 is generally perpendicular to the axis of the nozzle reactor 10. This configuration eliminates the elbow that can be created at the connection between the nozzle reactor 10 and the coil reactor 1120 (and which is shown in FIG. 4). Instead, the material leaving the nozzle reactor 10 travels into the coil reactor 1120 along a straight path and makes a gradual turn into the first coil of the reactor 1120. In order to facilitate this straight line path between the nozzle reactor 10 and the coil reactor 1120, the coil reactor 1120 may include a straight line extension piece 1122 extending from an injection end of the coil reactor 1120. In some embodiments, the straight line extension piece 1122 extends from the first curve at the injection end of the coil reactor 1120 to a location out beyond the periphery of the coil reactor 1120.

The configuration shown in FIG. 10 can be beneficial in several respects. The nozzle reactors that can be used as the first reactor 1200 in embodiments described herein work best when the amount of backflow/recirculation of material into the mixing chamber is minimized. Reducing backflow allows for the maintenance of a more stable jet within the mixing chamber, which in turn results in more rapid plug flow of materials through the reactor body. When this rapid plug flow is achieved, increases in conversion of feed material are realized. Additionally, reducing backflow further minimizes coke formation and wall scaling within the reactor body of the nozzle reactor 10. However, computational fluid dynamic work conducted on various embodiments of the nozzle reactors described herein (including the telescoping configuration shown in FIG. 3) has revealed that, while backflow is reduced, the problem still exists to an extent that conversion rates are not maximized. The backflow that continues to occur has been traced, at least in part, to the how the material exits the nozzle reactor 10 and transitions into the second reactor 1400. The elbow illustrated in FIG. 4 between the nozzle reactor 10 and the coil reactor 1120 will likely cause undesirable backflow regardless of how the reaction chamber of the nozzle reactor 10 is configured. The configuration shown in FIG. 10 alleviates this problem and reduces backmixing by providing for a smoother transition between the nozzle reactor and the coil reactor.

Another advantage with the configuration shown in FIG. 10 is that the overall height of the combined first and second reactors is reduced, which allows for larger-scale plants to be constructed. In the configuration shown in FIG. 4, the coil reactor must be oriented vertically under the nozzle reactor, which means the larger the coil reactor, the taller the combined structure. At some point, an upper limit the combined height of the structure is reached, at which point no further scale up can be accomplished. When the coil reactor is oriented horizontally so that its axis can be perpendicular to the axis of the nozzle reactor, the height of the combined structure essentially becomes dependent on the diameter of the coil reactor, which is generally much smaller than the length of the coil reactor. As a result, more scale up can be carried out without concern for crossing a threshold height of the combined structure.

The heavy hydrocarbon material is maintained at a temperature in the tubular reactor that is high enough to effectively crack it, but not high enough to cause excessive coking. In one embodiment, the temperature is at least approximately 410° C. or at least approximately 430° C. In another embodiment, the temperature may be approximately 410° C. to 490° C. or approximately 430° C. to 460° C. In yet another embodiment, the temperature may be no more than approximately 490° C. or no more than approximately 480° C.

In most situations it is not necessary to heat the tubular reactor. Large scale implementations do not require additional heat since the energy imparted to the feed 1600 and the cracking fluid 1800 before entering the system 100 is sufficient to achieve the desired conversion. However, if the material throughput is small relative to the size of the reactor tube, energy losses such as heat losses may be more acute. In these circumstances, it may be desirable to heat the reactor tube to maintain the desired conversion and/or product yields.

The residence time and linear velocity of the heavy hydrocarbon material in the tubular reactor may be adjusted as necessary to provide the desired conversion rate and product characteristics. In one embodiment, the residence time is at least approximately 0.05 s, at least approximately 0.10 s, or, desirably, at least approximately 0.15 s. In another embodiment, the residence time is approximately 0.05 s to 1 s, approximately 0.10 s to 0.8 s, or, desirably, approximately 0.15 s to 0.7 s. In yet another embodiment, the residence time is no more than approximately 1 s, no more than approximately 0.8 s, or, desirably, no more than approximately 0.7 s.

The linear velocity of the heavy hydrocarbon material in the tubular reactor may be at least approximately 4 m/s, at least approximately 5 m/s, or, desirably, at least approximately 6 m/s. In another embodiment, the linear velocity is approximately 4 to 40 m/s, approximately 5 to 35 nm/s, or, desirably 4 to 32 m/s. In yet another embodiment, the linear velocity is no more than approximately 40 m/s, no more than approximately 35 m/s, or, desirably, no more than approximately 32 m/s.

The pressure in the tubular reactor may vary as required to sustain the cracking reactors. In one embodiment, the tubular reactor may be at a pressure of approximately −34 kPa to 240 kPa or approximately −34 kPa to 140 kPa.

The size and dimensions of the tubular reactor are determined based on the capacity of the system. Higher flow rates will require a larger reactor and vice versa. The tubular reactor may be made of any suitable material such as metal, composites, and so forth. In one embodiment, the tubular reactor is made of SS-316.

The system 1000 cracks the heavy hydrocarbon material to produce lighter, lower molecular weight hydrocarbons. In one embodiment, the heavy hydrocarbon material is broken down into light hydrocarbon liquid distillate. The light hydrocarbon liquid distillate includes hydrocarbons having a molecular weight less than about 300 Daltons. In certain embodiments, about 25% to about 50% of the heavy hydrocarbon material cracked in the system 100 is converted into distillates.

The system 1000 may provide a much higher conversion rate than other comparable systems. The conversion rate of heavy hydrocarbon material into distillates in the system 1000 varies depending on the inputs, conditions, and a number of other factors. In one embodiment, the conversion rate of the system 1000 is at least approximately 15%, at least approximately 30%, or, desirably, at least approximately 35%.

The total residence time of the heavy hydrocarbon material in the nozzle reactor and the tubular reactor may vary widely. In one embodiment, the total residence time is at least approximately 0.2 s or at least approximately 0.3 s. In another embodiment, the total residence time is approximately 0.2 s to 2 s or approximately 0.3 s to 1.2 s. In yet another embodiment, the residence time is no more than approximately 2 s or no more than approximately 1.8 s.

As already mentioned above, one significant advantage of the system 1000 is that it produces very little, if any, coke and minimizes the amount of gas generated. This makes it possible to operate the system 1000 for long periods of time without cleaning. In one embodiment, the system 1000 may be operated indefinitely. Minimizing coke production also means that more of the heavy hydrocarbon material is conserved so that it can be used to produce higher value products than coke.

The amount of coke produced by the system 1000 can be determined by measuring the amount of coke precursors present in the feed 1600 and the effluent 1100. For example, the feed 1600 may include 0.1 wt % to 0.2 wt % of coke precursors and the effluent 120 may include 1 wt % to 2 wt % of coke precursors. This represents a substantial improvement over other technologies. In one embodiment, the effluent 1100 may include no more than 5 wt % of coke precursors or no more than 3 wt % of coke precursors.

Conventional systems for processing heavy hydrocarbon material increase the amount of micro carbon in the feed. The amount of micro carbon in the feed may be considered a proxy for determining how much coke is produced in some situations. The system 1000 reduces the amount of micro carbon present. The amount of micro carbon present in the effluent 1100 is less than in the feed 1600. This is another indication that the system 1000 is producing favorable results.

It should be appreciated that some portion of heavy hydrocarbon material may pass through the system 1000 without being cracked. This material may be referred to as non-participating heavy hydrocarbons or uncracked heavy hydrocarbons, since the reactors 1200, 1400 did not act on this material to crack it into lighter hydrocarbons. Heavy hydrocarbon material that is cracked but still qualifies as heavy hydrocarbon material may also be referred to as non-participating heavy hydrocarbons.

The effluent 1100 from the system 1000 may be transported to a separation unit that separates it into its constituent fractions. The separation unit may be any suitable separator capable of separating the effluent 1100. Examples of suitable separation units include, but are not limited to, atmospheric or vacuum distillation units, gravity separation units, filtration units, and cyclonic separation units.

The non-participating hydrocarbons may be subjected to further processing to upgrade it into more useful material. Various types of processing may be performed on the non-participating hydrocarbon for upgrading the non-participating hydrocarbon. The remaining fractions may be used as end products or be subjected to further processing.

Depending on the situation, it may not be necessary to crack all of the heavy hydrocarbon material in the feed 1600. It may only be necessary to upgrade a portion of the heavy hydrocarbon material to produce stable products such as synthetic crude oil, which can include some amount of heavy hydrocarbon material.

Turning to FIG. 2, another embodiment of a system 1500 for cracking heavy hydrocarbon material is shown. The system 1500 is similar to the system 1000 except that the non-participating heavy hydrocarbons 1520 are separated from the effluent 1100 in separation unit 1540 and recycled back to the first reactor 1200. The non-participating heavy hydrocarbons 1520 can be recycled back in perpetuity because the hydrogen interaction with the cracking fluid 1800 minimizes or prevents coke formation.

The system 1500 may provide a significantly higher conversion rate than other comparable systems including hydrocrackers. The conversion rate of heavy hydrocarbon material into distillates in the system 1500 varies depending on the inputs, conditions, and a number of other factors. In one embodiment, the conversion rate of heavy hydrocarbon material in the system 1500 may beat least approximately 65%, at least approximately 75%, or, desirably, at least approximately 90%. In another embodiment, most or at least substantially all of the heavy hydrocarbon material that enters the system 1500 is cracked to distillates. The amount of non-participating heavy hydrocarbon material and/or coke left over from the process may be minor.

In another embodiment, the non-participating hydrocarbons may be injected into a third and fourth reactor positioned in series. The third reactor may be a nozzle reactor that is designed similarly or identical to the first nozzle reactor. The fourth reactor may be a tubular reactor that is similar or identical to the second reactor. The dimensions of the additional nozzle and tubular reactor may be identical to the dimensions of the first nozzle and tubular reactor, or they may be scaled up or down. The non-participating hydrocarbon stream may also be pretreated before entering the third and fourth reactor in a similar or identical way as those described above.

It should be noted that the systems 1000, 1500 crack the heavy hydrocarbon material without the use of a catalyst or added elemental hydrogen. Thus, the systems 1000, 1500 are not catalytic cracking processes or hydro-cracking processes.

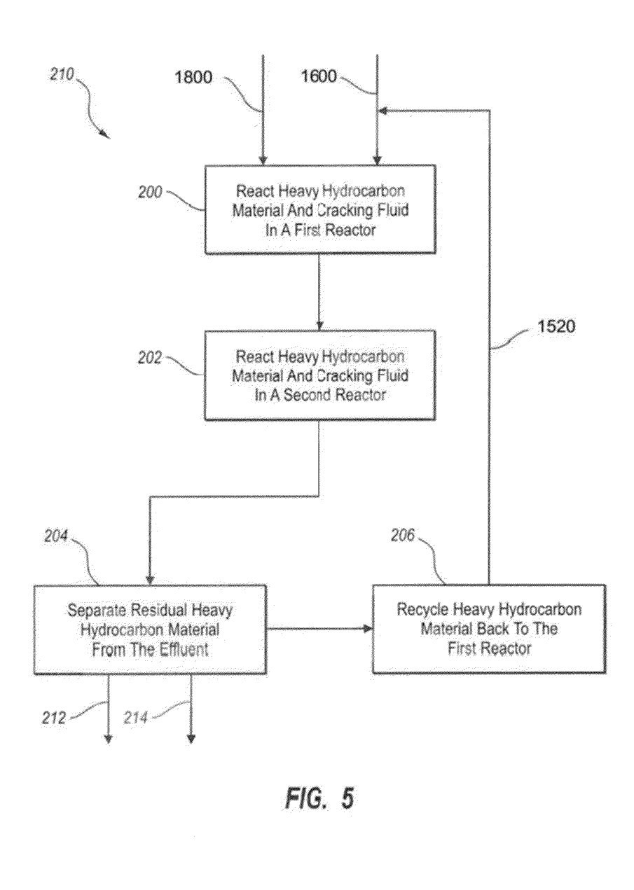

A method 210 for cracking heavy hydrocarbon material is depicted in FIG. 5. The method includes the step 200 of reacting the heavy hydrocarbon material and the cracking fluid 1800 in the first reactor 1200 to form a first effluent material. At step 202, the first effluent material is reacted in the second reactor 1400 to form a second effluent material. In one embodiment, the first effluent is discharged directly from the first reactor 1200 to the second reactor 1400 without undergoing any intermediate processing or storage.

The second effluent material is separated at step 204 to isolate the non-participating heavy hydrocarbon material from distillates 212 and gas 214. The non-participating heavy hydrocarbon material 1520 is then recycled back to the first reactor 1200. In some embodiments the separation and recycling step may be skipped in favor of sending the effluent on for further processing (e.g., catalytic cracking, hydro-cracking, etc.).

### EXAMPLES

The following examples are provided to further illustrate the subject matter disclosed herein. These examples should not be considered as limiting or restricting the claimed subject matter in any way.

### Example 1

This example compares the conversion of heavy hydrocarbon material in a nozzle and coil reactor versus a nozzle reactor alone. The hydrocarbon material used in this example is Cold Lake raw bitumen and it has the properties shown in Table 2. The cracking fluid is steam.

TABLE 2
Feed hydrocarbon material
Hydrocarbon material properties

| | |
|---|---|
| API | 10.4 |
| Sulfur (wt %) | 4.8 |
| Micro carbon (wt %) | 16.9 |
| Heavy hydrocarbon material (wt %) | 59.2 |

The nozzle reactor is substantially the same as the nozzle reactor shown and described in U.S. Patent Application Publication No. 2009/0266741. The specifications of the nozzle reactor are given in Table 3. The coil reactor is a 2194.4 cm long tube that has an internal diameter of 1.6 cm that is uniform throughout its entire length. The coil reactor has a spiral shape.

TABLE 3
Nozzle reactor specifications

| Nozzle Reactor Component | Size (mm) |
|---|---|
| Injection passage injection section diameter | 3.0 |
| Injection passage mid-section diameter | 1.3 |
| Injection passage ejection section diameter | 2.26 |
| Injection passage length | 20 |
| Interior reaction chamber injection end diameter | 3.7 |
| Interior reaction chamber ejection end diameter | 16 |
| Interior coil reactor length | 21944 |
| Overall length of nozzle and coil reactor | 21964 |
| Overall nozzle reactor outside diameter | 19 |

Each run is conducted as follows. The cracking fluid is superheated to approximately 650° C. and approximately 2000 kPa. The cracking fluid is sent to the nozzle reactor where it reaches a supersonic velocity of approximately Mach 2.8.

The heavy hydrocarbon material is preheated to a temperature of approximately 380° C. and injected into the nozzle reactor where it reacts with the superheated cracking fluid. The nozzle reactor converts part of the heavy hydrocarbon material into lighter hydrocarbons that have a boiling point below 525° C.

The partially upgraded feed from the nozzle reactor is discharged to the coil reactor. The coil reactor provides the residence time at cracking temperatures of 420 to 470° C. to further convert the heavy hydrocarbon material into lighter distillates.

Four runs are performed with the first run serving as a control since only the nozzle reactor was used. A recycle stream was not used in any of the runs. Table 4 shows the characteristics and results of each run.

TABLE 4
Conversion effectiveness of nozzle and coil reactor combination

| | | Coil Reactor | Conver- | Distillates** |
|---|---|---|---|---|
| | | Residence | sion* | Produced |
| Sample | Reactor Type | Time (s) | (%) | (vol %) |
| N1 | Nozzle only | NA | 4.6 | 4.9 |
| NC1 | Nozzle and Coil | 0.15 | 16.1 | 16.0 |
| | Reactor | | | |
| NC2 | Nozzle and Coil | 0.3 | 20.7 | 19.3 |
| | Reactor | | | |
| NC3 | Nozzle and Coil | 0.6 | 30.3 | 29.2 |
| | Reactor | | | |

*Conversion refers to the amount of heavy hydrocarbon material converted to distillates.

This example demonstrates that the coil reactor increases the conversion of the heavy hydrocarbon material versus the nozzle reactor alone. The coil reactor provides increased residence time at high temperature, which drives conversion of the heavy hydrocarbon material.

### Example 2

This example compares the cracking efficiency of a straight tubular reactor and a coil reactor. The procedure is the same as Example 1 except that the residual heavy hydrocarbon material discharged from the coil reactor is recycled back to the feed. Recycle is not used with the straight tubular reactor. The results are shown in Table 5.

TABLE 5
Conversion efficiency of straight tubular
reactor versus a coil reactor

| | | Coil Reactor | | Conver- | Reaction |
|---|---|---|---|---|---|
| Sam- | | Residence | Temp | sion* | Rate |
| ple | Reactor Type | Time (s) | (C.) | (%) | Constant Ln(K) |
| NST | Nozzle and | 0.3 | 460 | 26 | −0.13 |
| | Straight | | | | |
| | Tubular Reactor | | | | |
| NCR | Nozzle and | 0.3 | 445 | 21 | −.07 |
| | Coil Reactor | | | | |

*Conversion refers to the amount of heavy hydrocarbon material converted to distillates.

This example demonstrates the nozzle and coil reactor combination is more efficient than the nozzle and straight tubular reactor. The reaction rate constant of the nozzle/coil combination is twice that of the nozzle/straight tubular combination.

### Example 3

The procedure for this example is the same as Example 1. One run was performed using only the nozzle reactor and another run used both the nozzle reactor and the coil reactor. The carbon profile for each run is shown in Table 6.

TABLE 6
Conversion of heavy hydrocarbon material

| Carbon | | Nozzle Reactor Only | Nozzle/Coil Reactor |
|---|---|---|---|
| Profile | Feed (wt %) | Profile (%) | Profile (%) |
| C1-C50 | 51.4 | 57.3 | 68.3 |
| C50-C100 | 17.3 | 18.8 | 17.6 |
| C100+ | 31.3 | 23.8 | 14.1 |

* Conversion refers to the amount of heavy hydrocarbon material converted to distillates.

This example demonstrates that the combination of the nozzle and coil reactor converts over 50 wt % of the heaviest material (the C100+ material) into C50-C100. It is significantly better than the conversion achieved by the nozzle reactor alone. It should be noted that C42+ material has a boiling point of 525° C. or higher.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. The subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

As used herein, spatial or directional terms, such as “left,” “right,” “front,” “back,” and the like, relate to the subject matter as it is shown in the drawing FIGS. However, it is to be understood that the subject matter described herein may assume various alternative orientations and, accordingly, such terms are not to be considered as limiting. Furthermore, as used herein (i.e., in the claims and the specification), articles such as “the,” “a,” and “an” can connote the singular or plural. Also, as used herein, the word “or” when used without a preceding “either” (or other similar language indicating that “or” is unequivocally meant to be exclusive—e.g., only one of x or y, etc.) shall be interpreted to be inclusive (e.g., “x or y” means one or both x or y). Likewise, as used herein, the term “and/or” shall also be interpreted to be inclusive (e.g., “x and/or y” means one or both x or y). In situations where “and/or” or “or” are used as a conjunction for a group of three or more items, the group should be interpreted to include one item alone, all of the items together, or any combination or number of the items. Moreover, terms used in the specification and claims such as have, having, include, and including should be construed to be synonymous with the terms comprise and comprising.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A heavy hydrocarbon cracking system comprising:
a nozzle reactor comprising:
a main passage including a first region followed by a second region, the first region and the second region each including a convergent section, a throat, and a divergent section;
a feed passage in fluid communication with the main passage; and
a first effluent material output;
wherein the feed passage meets the main passage between the throat in the first region and the throat in the second region and a central axis of the nozzle reactor runs through the main passage; and
a coil reactor having a central axis and in fluid communication with the first effluent material output, the coil reactor including a second effluent material output;
wherein the central axis of the nozzle reactor is perpendicular to the central axis of the coil reactor.

2. The heavy hydrocarbon cracking system of claim 1 also comprising a heavy hydrocarbon separator in fluid communication with the second effluent material output.

3. The heavy hydrocarbon cracking system of claim 2 wherein the heavy hydrocarbon separator includes a heavy hydrocarbon material output and the nozzle reactor includes a heavy hydrocarbon material recycle input, wherein the heavy hydrocarbon material output is in fluid communication with the heavy hydrocarbon material recycle input.

4. The heavy hydrocarbon cracking system of claim 1 wherein the main passage has a circular cross-section.

5. A system comprising:
a feed including heavy hydrocarbon material;
a cracking fluid;
a nozzle reactor having a central axis and that receives the feed and the cracking fluid and outputs a first effluent material; and
a coil reactor having a central axis and in fluid communication with the nozzle reactor;
wherein the coil reactor receives the first effluent material and outputs a second effluent material and wherein the central axis of the nozzle reactor is perpendicular to the central axis of the coil reactor.

6. The system of claim 5 wherein the nozzle reactor and the coil reactor convert at least a portion of the heavy hydrocarbon material in the feed into distillates.

7. The system of claim 5 wherein the nozzle reactor receives heavy hydrocarbon material separated from the second effluent material.

8. The system of claim 5 further comprising a separator that separates heavy hydrocarbon material from the second effluent material.

9. The system of claim 5 wherein the cracking fluid reaches Mach 1 in the nozzle reactor.

10. The system of claim 5 wherein the coil reactor has a residence time of approximately 0.05 s to 1 s.

11. The system of claim 5 wherein the feed is at least approximately 95 wt % heavy hydrocarbon material and the second effluent material includes no more than 5 wt % of coke precursors.

12. A method comprising:
reacting heavy hydrocarbon material with a cracking fluid in a nozzle reactor having a central axis and producing a first effluent material;
reacting the first effluent material in a coil reactor having a central axis oriented perpendicular to the central axis of the nozzle reactor.

13. The method of claim 12 wherein the coil reactor outputs a second effluent material, the method comprising separating heavy hydrocarbon material from the second effluent material and recycling it back to the nozzle reactor.

14. The method of claim 12 comprising converting at least approximately 75% of the heavy hydrocarbon material that enters the nozzle reactor into distillates.

15. The method of claim 12 comprising accelerating the cracking fluid in the nozzle reactor to at least Mach 1.

16. The method of claim 12 wherein the coil reactor has a residence time of approximately 0.05 s to 1 s.

17. The heavy hydrocarbon cracking system of claim 1, wherein the coil reactor includes a straight line extension section at an injection end of the coil reactor that is configured for receiving material from the nozzle reactor.

18. The heavy hydrocarbon cracking system of claim 17, wherein the coil reactor has a perimeter and the straight line extension section extends beyond the perimeter of the coil reactor.

19. The system of claim 5, wherein the coil reactor includes a straight line extension section at an injection end of the coil reactor that is configured for receiving material from the nozzle reactor.

20. The system of claim 19, wherein the coil reactor has a perimeter and the straight line extension section extends beyond the perimeter of the coil reactor.

21. The method of claim 12, further comprising the step of transferring the first effluent material from the nozzle reactor to the coil reactor using a straight line extension section extending from an injection end of the coil reactor.
